(19) United States
(12) Patent Application Publication
(10) Pub. No.: US 2005/0266841 A1
(43) Pub. Date: Dec. 1, 2005

(54) Apparatus and method for processing signal in base station transceiver system

(76) Inventor: Jin-Kyu Lee, Seoul (KR)

Correspondence Address: Robert E. Bushnell;Suite 300, 1522 K Street, N.W., Washington, DC, 20005-1202, US

(21) Appl. No.: 11/010,275

(22) Filed: Dec. 14, 2004

(30) Foreign Application Priority Data
May 31, 2004 (KR) 2004-39365

(51) Int. Cl. H04Q 7/20

(52) U.S. Cl. 455/423

(57) ABSTRACT

An apparatus and method for processing a signal in a base station transceiver system are disclosed. According to the present invention, a mobile communication service is provided to more mobile stations in a service area of the base station transceiver system by effectively connecting a plurality of RF (Radio Frequency) units (RRUs) to the base station transceiver system of the mobile communication system through a network, the base station transceiver system individually controls the performance of each RF unit, and a uniform quality of service is provided to a plurality of mobile stations, each being provided with the mobile communication service through different RRUs, by applying and processing gain of different weights from each other to a signal exchanged between the plurality of RF units according to the connection structure.

### CLAIM OF PRIORITY

This application makes reference to, incorporates the same herein, and claims all benefits accruing under 35 U.S.C. § 119 from an application for APPARATUS AND METHOD FOR PROCESSING SIGNAL IN BASE STATION TRANSCEIVER SYSTEM earlier filed in the Korean Intellectual Property Office on 31 May 2004 and there duly assigned Serial No. 2004-39365.

### BACKGROUND OF THE INVENTION

1. Field of the Invention

The present invention relates to an apparatus and method for processing a signal in a base station transceiver system and, more particularly, to an apparatus and method for processing a signal in a base station transceiver system, in which a plurality of remote radio frequency (RF) units (RRUs) are connected to a base station transceiver system (BTS) using a plurality of hubs and a gain of predetermined weight is differentially applied to a signal transmitted from a lower stage to an upper stage so that subscribers, each being provided with a mobile communication service through each RRU, are provided with the same quality of service.

2. Description of the Related Art

Generally, a mobile communication system includes a mobile switching center (MSC), a base station system (BSS), and a terminal (or a mobile station; MS).

The base station system may include a base station controller (BSC) and a base station transceiver system (BTS), both of which are connected to each other through a cable to be operable in communication environments.

This base station system is in wireless communication with the mobile station, and is usually connected to a public switched telephone network (PSTN) through a cable, thereby allowing communication between the mobile station and the public switched telephone network.

The mobile communication systems may be classified into a digital cellular system (DCS), a personal communications system (PCS), an International mobile telecommunication 2000 (IMT-2000) system, and the like according to their communication method.

These mobile communication systems may be classified by several criteria. Representatively, the mobile communication systems may be classified by a transmission frequency band. For example, the DCS is a way to which 869 through 894 MHz is assigned as the transmission frequency band; the PCS is a way to which 1840 through 1870 MHz is assigned as the transmission frequency band; and the IMT-2000 system is a way to which 2110 through 2170 MHz is assigned as the transmission frequency band.

### SUMMARY OF THE INVENTION

It is an objective of the present invention to provide an apparatus and method for processing a signal in a base station transceiver system in which a plurality of RF units are efficiently connected to a base station transceiver system in a mobile communication system over a network, the base station transceiver system individually controls the performance of each RF unit over the network, and a gain is applied to a signal that is exchanged through each RF unit.

According to an aspect of the present invention, an apparatus for processing a signal in a base station transceiver system connected with a plurality of RF units through a plurality of ports, the apparatus includes: a gain controller for providing a weighted gain signal corresponding to a signal received through each of the ports according to a connection structure of each of the RF units connected through each port; and a signal processor for converting the signals to a signal having a predetermined size according to the signal received through each port and the weighted gain signal provided from the gain controller, and outputting the converted signal over a network.

The signal processor includes: a plurality of multipliers for multiplying the signal received through each port by the weighted gain signal corresponding to each port; an adder for adding signals calculated by the multipliers; and a divider for dividing the calculated signal by a predetermined value as a divisor and outputting a resultant signal to the network, in order to transmit the signal calculated by the adder to the network.

According to another aspect of the present invention, a mobile communication system includes: at least one remote RF unit (RRU) for, when connecting to a base station transceiver system (BTS) over a network, converting an RF signal, which is an analog signal transmitted from a mobile station (MS), to a baseband signal of a digital signal, transmitting a confirmation signal including performance information to the base station transceiver system, and establishing performance according to a control signal transmitted from the base station transceiver system; at least one hub connected to the at least one RRU over the network, for transmitting an initialization signal according to a connection structure of a lower stage to the base station transceiver system, and for assigning unique information to each of the RRUs according to an arrangement signal received from the base station transceiver system; and a base station transceiver system for, when receiving the confirmation signal and the initialization signal over the network, assigning unique information according to the connection structure of each RRU and each hub, generating a control signal for controlling performance of each RRU based on the unique information, and transmitting the control signal over the network.

Meanwhile, according to yet another aspect of the present invention, a method for processing a signal in a mobile communication system connected to at least one RF unit through a plurality of ports, the method includes: recognizing a connection structure of a lower stage from a signal transmitted from each of the RF units; calculating a gain to be applied to a signal received through each port, based on the recognized connection structure, and generating a weighted gain signal corresponding to each port; and calculating a signal to be transmitted over the network, based on the signal received through each port and the weighted gain signal corresponding to each port.

Calculating the signal in the method for processing the signal in the mobile communication system according to the present invention includes: multiplying the signal received through each port by the weighted gain signal corresponding to each port to obtain a plurality of multiplication signals, respectively; adding the obtained multiplication signals to obtain an addition signal; and dividing the obtained addition signal by a predetermined value as a divisor to obtain a predetermined signal.

In addition, according to yet another aspect of the present invention, a method for processing a signal in a mobile communication system in which a plurality of remote RF units (RRUs) are connected to a base station transceiver system through at least one hub, the method includes: transmitting, by each of the RRUs, a confirmation signal including initial information to the hub or the base station transceiver system of an upper stage when connecting to the base station transceiver system over the network; recognizing, by each hub, a connection structure of the lower stage to transmit an initialization signal including structure information to the base station transceiver system when connecting to the base station transceiver system or receiving the confirmation signal from the RRU; assigning, by the base station transceiver system, unique information to each hub and each RRU based on the connection structure of the lower stage; and individually controlling, by the base station transceiver system, performance of each RRU by transmitting to each RRU a control signal including performance control information using the assigned unique information.

Further, the method further includes: setting, by each RRU, its performance in response to the control signal, and transmitting a dynamic report signal including state information in a predetermined period; transmitting, by a new server, an initialization signal including structure information to the hub or the base station transceiver system of the upper stage when the new hub is connected over the network; and re-assigning, by the base station transceiver system, unique information to each hub or each RRU according to the structure information included in the received initialization signal.

Transmitting the control signal according to the present invention includes: generating, by the base station transceiver system, a control signal and transmitting the control signal to the hub of the lower stage using the unique information assigned to one RRU whose performance is to be controlled; and recognizing, by the hub, a port through which the control signal is to be output, from the unique information included in the control signal, and outputting the control signal to the port.

In addition, assigning the unique information according to the present invention includes: recognizing, by the base station transceiver system, the connection structure of the lower stage from the initialization signal; assigning the unique information to the ports of each hub based on the recognized connection structure; and assigning the unique information to each RRU according to the unique information assigned to each port in a path, along which the confirmation signal transmitted by each RRU is transmitted to the base station transceiver system.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is an internal block diagram illustrating a function of a base station transceiver system (BTS);

FIG. 2 is a block diagram illustrating connection of a plurality of RF units to a base station transceiver system;

FIG. 3 is an overall block diagram illustrating a base station transceiver system according to an exemplary embodiment of the present invention;

FIGS. 4A and 4B are flow diagrams illustrating a signal exchange according to an exemplary embodiment of the present invention;

FIG. 5 is a diagram illustrating assignment of unique information according to an exemplary embodiment of the present invention;

FIG. 6 is an internal block diagram illustrating the configuration of a hub according to an exemplary embodiment of the present invention;

FIG. 7 is a flowchart illustrating a method for processing a signal according to one exemplary embodiment of the present invention; and

FIG. 8 is a flowchart illustrating a method for processing a signal according to another exemplary embodiment of the present invention.

### DETAILED DESCRIPTION OF THE INVENTION

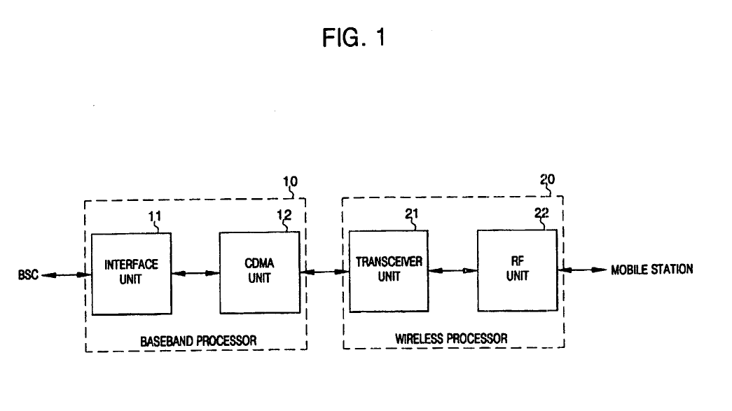

FIG. 1 is an internal block diagram illustrating a function of a base station transceiver system (BTS).

Referring to FIG. 1, a base station transceiver system may be divided into a baseband processor 10 and a wireless processor 20. The baseband processor 10 may include an interface unit 11 and a code division multiple access (CDMA) unit 12, and the wireless processor 20 may include a transceiver unit 21 and a radio frequency (RF) unit (RRU) 22.

The interface unit 11 operates a relay line matching function between the base station transceiver system and a base station controller (BSC: not shown), and matches a signal received from the base station controller.

For example, the interface unit 11 converts a 64 Kbps signal, which is received from the base station controller, to a 16 Kbps signal through matching in a ratio of 1:4, and processes channel distribution.

And, the CDMA unit 12 performs modulation/demodulation for each channel, and processes sync, paging, access, forward and reverse traffics.

Further, the CDMA unit 12 up-converts a baseband signal to an intermediate frequency (4.95 MHz) or down-converts the intermediate frequency to the baseband signal.

The transceiver unit 21 in the wireless processor 20 converts the intermediate frequency signal (4.95 MHz), for forward link transmit, to an RF signal (1.84 to 1.85 MHz), and converts the RF signal, for reverse link receiver, to the intermediate frequency signal.

And, the RF unit 22 amplifies the RF signal received from the transceiver unit 21 with a constant gain and then outputs the amplified RF signal to a mobile station (not shown) via an antenna (not shown).

Further, the RF unit 22 may use a duplexer to allow a transmission (Tx) antenna and a reception (Rx) antenna to be shared, and transmits the RF signal, which is received through the Rx antenna, to the transceiver unit 21.

Recently, the base station transceiver system connects a plurality of RF units 22 to one base station transceiver system in order to accommodate more subscribers.

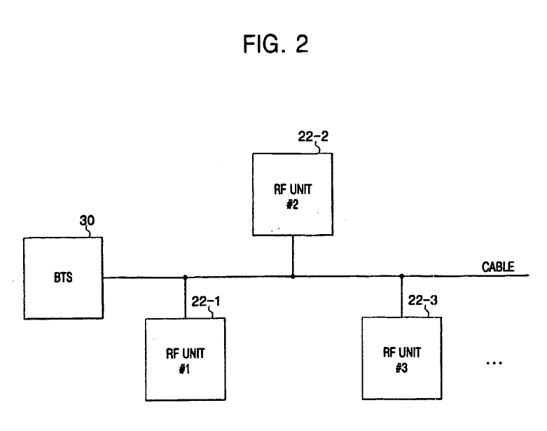

FIG. 2 is a block diagram illustrating a connection of a plurality of RF units to a general base station transceiver system.

As shown in FIG. 2, a plurality of RF units 22-1 to 22-3 are connected to one base station transceiver system (BTS) 30 through a cable.

The plurality of RF units 22-1 to 22-3 are properly arranged in a service area of the base station transceiver system 30; receive an RF signal transmitted from a mobile station (not shown), which is included in each area; transmit the signal to the base station transceiver system 30; and transmit the RF signal, which is received from the base station transceiver system 30, to each mobile station.

At this time, an analog signal is exchanged through the cable by which each of the RF units 22-1 to 22-3 and the base station transceiver system 30 are interconnected.

Each of the RF units 22-1 to 22-3 transmits the RF signal, which is received from the base station transceiver system 30, to the mobile station; amplifies the RF signal received wirelessly from the mobile station with a constant gain; and transmits the amplified RF signal to the base station transceiver system 30.

However, in the case where each of the RF units 22-1 to 22-3 and the base station transceiver system 30 exchange the analog signal there between through the cable, installation cost is excessively paid to properly distribute each of the RF units 22-1 to 22-3 in a service area of the base station transceiver system 30.

And, in the case where the base station transceiver system 30 should control the performance of each of the RF units 22-1 to 22-3, for example, when the performance of the RF signal output should be improved due to the increased number of mobile stations in an area of the first RF unit 22-1, there arises a problem that the base station transceiver system 30 cannot control the output performance of the first RF unit 22-1 except for the second RF unit 22-2 and the third RF unit 22-3.

That is, the base station transceiver system 30 is adapted to transmit a control signal as an analog signal to each of the RF units 22-1 to 22-3 through the cable, thus causing the operation for each of the RF units 22-1 to 22-3 to be inefficient because the performance of all RF units 22-1 to 22-3 should be equally controlled in order to control the performance of the first RF unit 22-1.

Further, there arises a problem that subscribers, each being provided with a mobile communication service through each mobile station, cannot be provided with the same quality of service because the mobile stations, which exchange signals through each of the RF units 22-1 to 22-3, exchange different signals according to the performance of the RF units 22-1 to 22-3 or the connection structure of the RF units 22-1 to 22-3.

A preferred embodiment of the present invention will be described herein below with reference to the accompanying drawings. In the following description, well-known functions or constructions are not described in detail since they would obscure the invention unnecessarily.

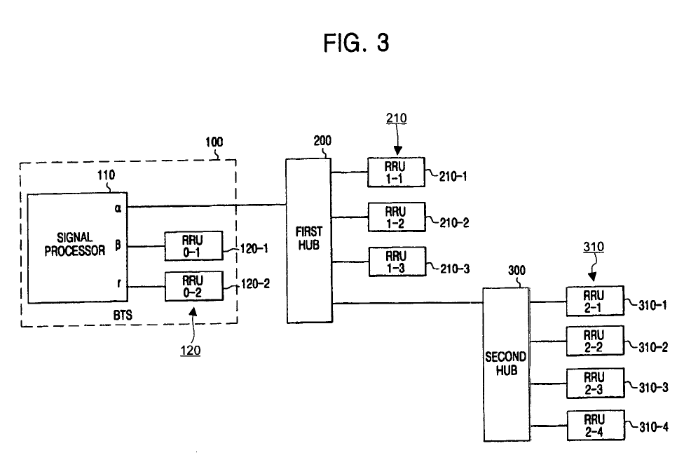

FIG. 3 is an overall block diagram illustrating a base station transceiver system according to an exemplary embodiment of the present invention.

Referring to FIG. 3, a base station transceiver system (BTS) 100 includes a signal processor 110, and a plurality of remote RF units (RRUs) 120-1 and 120-2. The signal processor 110 is connected with the plurality of RRUs 120-1 and 120-2 and a first hub 200 over a network.

At this time, alpha, beta, and gamma of the signal processor 110 indicate three sectors of the base station transceiver system 100, and each of the sectors may be responsible for signal transmission and reception in the range of 120°.

Further, the network, over which the base station transceiver system 100 and the respective hubs 200 and 300 are interconnected, may be either a wireless network or a wired network.

Hereinafter, although the case where the base station transceiver system 100 is of a three-sector way will be described in the detailed description of the invention, it will be understood that the present invention may be equally applied to the case where the system is of a 1 sector (omhi) way or a multi-sector way.

Further, the case where the base station transceiver system 100 is connected to the respective hubs 200 and 300 and the respective RRUs over a LAN, which is a wired network, will be described. Note that a wireless local area network (WLAN) could be utilized.

The base station transceiver system 100 is connected to the first hub 200 through the LAN, and the first hub 200 is connected to a plurality of RRUs 210-1, 210-2 and 210-3 and a second hub 300 through the LAN.

Further, the second hub 300 is connected to a plurality of RRUs 310-1, 310-2, 310-3 and 310-4 through the LAN.

The signal processor 110 in the base station transceiver system 100 analyzes a baseband signal received from each of the RRUs 120, 210 and 310 or each of the hubs 200 and 300 to transmit it to a base station controller (BSC), and transmits the baseband signal received from BSC to a mobile station through each of the RRUs 120, 210 and 310 or each of the hubs 200 and 300.

Further, the signal processor 110 recognizes the structure of each of the hubs 200 and 300 and the RRUs 120, 210 and 310 of a lower stage, assigns unique information to each of the RRUs 120, 210 and 310, transmits the baseband signal, received from the BSC, using assigned unique information, and controls the performance of each of the RRUs 120, 210 and 310 in response to a request of a manager or a prescribed program.

Each of the RRUs 120, 210 and 310 converts the baseband signal, which is transmitted from the signal processor 110 and the respective hubs 200 and 300, to an RF signal to transmit the converted RF signal to the mobile station, and converts the RF signal, received from the mobile station, to the baseband signal to transmit the converted baseband signal to the signal processor 110 and the respective hubs 200 and 300.

Further, when each of the RRUs 120, 210 and 310 is connected through the network, each transmits a confirmation signal in a predetermined period and sets its performance according to a control signal, which is transmitted from the signal processor 110.

At this time, the performance set by each of the RRUs 120, 210 and 310 is a performance used when the RRU exchanges an RF signal with a mobile station, such as output performance and power performance of the RF signal.

Each of the hubs 200 and 300 adds the baseband signal transmitted from the plurality of RRUs 210 and 310 to a predetermined power of baseband signal, and transmits the added signal to the base station transceiver system 100, which is the uppermost stage.

At this time, the second hub 300 adds a plurality of baseband signals received from the respective RRUs 310-1 to 310-4 to a predetermined power of baseband signal, and transmits the added signal to the first hub 200 of the upper stage.

The first hub 200 adds the baseband signal received from the second hub 300, a plurality of baseband signals received from the respective RRUs 210-1 to 210-3 to a predetermined power of baseband signal, and transmits the added signal to the base station transceiver system 100.

Further, each of the hubs 200 and 300 copies the baseband signal received from the base station transceiver system 100 and transmits the copied signal to each of the RRUs 210 and 310.

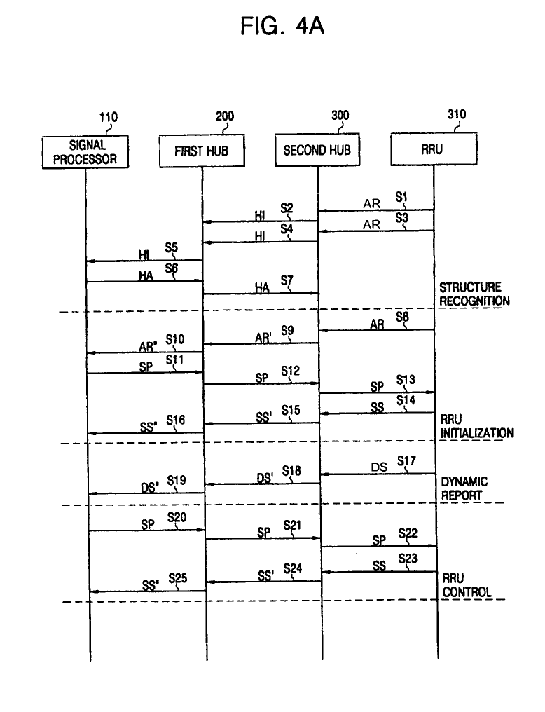

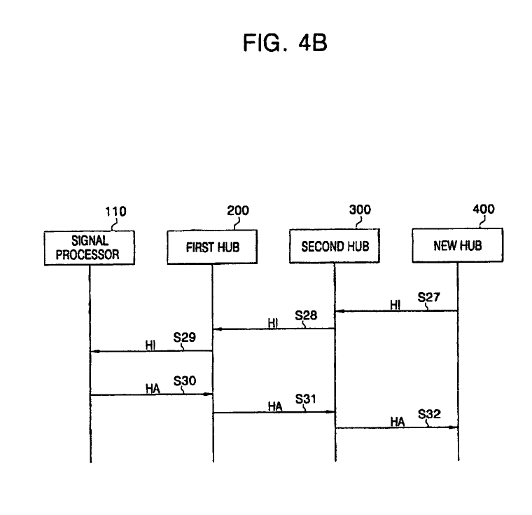

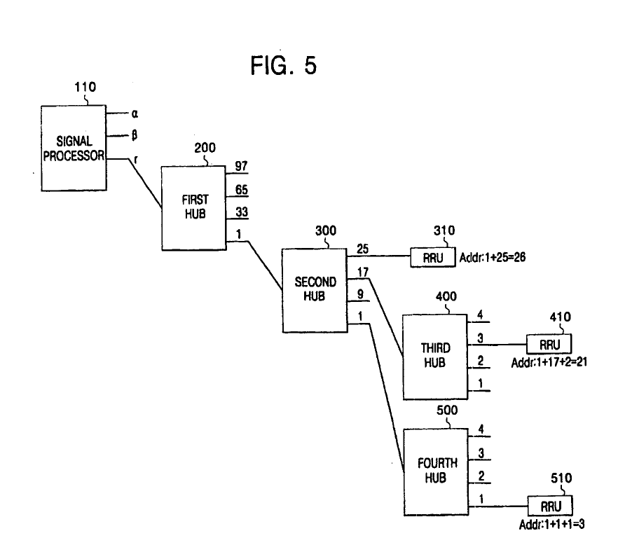

The following description refer to FIG. 4A through FIG. 5.

When a base station transceiver system 100, a first hub 200, a second hub 300, and an RRU 310 are interconnected through the LAN, the RRU 310 transmits a confirmation signal AR including performance information to the second hub 300 of the upper stage (S1).

For example, the case where the RRU 310 transmitting the confirmation signal is connected to the second hub 300 will be described. The RRU 310 transmits the confirmation signal AR to the second hub 300, and the second hub 300 transmits a hub initialization (HI) signal in response to the confirmation signal AR transmitted from the RRU 310 to the first hub 200, which is the upper stage (S2).

Further, the RRU 310 transmit the confirmation signal AR to the second hub 300, which is the upper stage, in a predetermined period (S3), and the second hub 300 transmits the hub initialization signal HI based on the confirmation signal AR received from the RRU 310 in a predetermined period, to the first hub 200 (S4).

The first hub 200 transmits the hub initialization signal HI, received from the second hub 300, to the signal processor 110 of the base station transceiver system 100 (S5).

At this time, the confirmation signal AR that the RRU 310 transmits to the upper stage includes performance information, such as channel information, power information and temperature information of the RRU 310.

Further, the hub initialization signal HI that the second hub 300 transmits to the first hub 200 of the upper stage includes structure information of RRU 310, connected to the lower stage of the relevant hub, and of the hub.

The signal processor 110 in base station transceiver system 100 recognizes the structure of the lower stage from the structure information included in the hub initialization signal HI, which is transmitted from the hub 200 of the lower stage.

Further, the signal processor 110 assigns a level to each of the hubs 200 and 300 of the lower stage, and transmits a hub arrangement signal (HA) to each of the hubs 200 and 300 (S6 and S7).

At this time, the signal processor 110 may assign a level to each of the hubs 200 and 300 according to the structure of the hubs 200 and 300 of the lower stage, as denoted in Table 1.

TABLE 1

| | Level |
|---|---|
| 0 | Signal processor = > HUB 0 |
| 1 | HUB 0 = > HUB 1 |
| 2 | HUB 1 = > HUB 2 |
| 3 | HUB 2 = > HUB 3 or HUB 4 |

As illustrated in Table 1, the signal processor 110 may assign the uppermost order level, ‘0’, to itself, assign a next level, ‘1’, to the first hub 200 of the near lower stage, and assign ‘2’ to the second hub 300 of the next lower stage.

That is, the signal processor 110 may assign a level to each of the hubs 200 and 300 according to a structure in which signals, transmitted from the RRUs 120, 210 and 310 that are connected over the network, are passed.

As such, the signal processor 110 recognizes a connection structure of the hubs 200 and 300 and the RRUs 120, 210 and 310 of the lower stage based on the signal transmitted from each of the RRUs 120, 210 and 310 and each of the hubs 200 and 300, and assigns unique information according to the connection structure of each of the hubs 200 and 300 and the RRUs 120, 210 and 310.

As shown in FIG. 5, a diagram illustrating assignment of unique information, a first hub 200 is connected to a base station transceiver system 100 through the LAN, a second hub 300 is connected to a lower stage of the first hub 200, and a third hub 400 and a fourth hub 500 are connected to a lower stage of the second hub 300.

As described with respect to FIG. 4A, when each of RRUs 310, 410 and 510 is connected to the base station transceiver system 100 over the network, each transmits a confirmation signal AR including performance information in a predetermined period, and each of the hubs 200, 300, 400 and 500 transmits an initialization signal HI to the next upper stage.

Further, when receiving the confirmation signal AR through a port from the lower stage, each of the hubs 200, 300, 400 and 500 determines that the RRUs 310, 410 and 510 are connected to the lower stage through the relevant port, and when receiving the initialization signal HI, it determines that the hub is connected to the lower stage through the relevant port.

The signal processor 110 and each of the hubs 200, 300, 400 and 500 assign address information as unique information to each of the hubs 200, 300, 400 and 500 and each of the RRUs 310, 410 and 510 of the lower stage.

For instance, the signal processor 110 may assign an address as unique information to each port of each of the hubs 200, 300, 400 and 500, as denoted in the following table 2.

TABLE 2

| Hub | Port | Address information |
|---|---|---|
| First hub | First port | 1 |
| | Second port | 33 |
| | Third port | 65 |
| | Fourth port | 97 |
| Second hub | First port | 1 |
| | Second port | 9 |
| | Third port | 17 |
| | Fourth port | 25 |
| Third hub | First port | 1 |
| | Second port | 2 |
| | Third port | 3 |
| | Fourth port | 4 |
| Fourth hub | First port | 1 |
| | Second port | 2 |
| | Third port | 3 |
| | Fourth port | 4 |

As denoted in Table 2, each port of each of the hubs 200, 300, 400 and 500 may be assigned address information, and each of the RRUs 310, 410 and 510 connected over the network may be assigned address information as unique information, using the address information assigned to each port.

That is, the relevant RRUs 310, 410 and 510 may be assigned address information according to the address information assigned to each port of each of the hubs 200, 300, 400 and 500 belonging to a pass path, along which the confirmation signal AR transmitted from the RRUs 310, 410 and 510 is transmitted to the signal processor 110 in the base station transceiver system 100.

The address information of the RRU 310 connected to the fourth port of the second hub 300 may be assigned as ‘26’ obtained by adding ‘25’ assigned to the fourth port of the second hub 300 and ‘1’ assigned to the first port through which the second hub 300 is connected to the first hub 200, and the address information of the RRU 410 connected to the third port of the three hub 400 may be assigned as ‘21’ obtained by adding ‘3’ assigned to the third port of the three hub 400, ‘17’ assigned to the third port of the second hub 300, and ‘1’ assigned to the first port of the first hub 200.

And, the address information of the RRU 510 connected to the first port of the fourth hub 500 may be assigned as ‘3’ obtained by adding ‘1’ being address information assigned to the first port of the fourth hub 500, ‘1’ assigned to the first port of the second hub 300, and ‘1’ assigned to the first port of the first hub 200.

Meanwhile, when the signal processor 110 recognizes the connection structure of the lower stages and then assigns address information to each of the RRUs 120, 210 and 310, each of the RRUs 120, 210 and 310 transmits a confirmation signal AR including initial performance information to the second hub 300 connected to the upper stage in a predetermined period (S8), as shown in FIG. 4A.

The second hub 300 copies the confirmation signal AR transmitted from the RRU 310 to transmit the copied signal AR′ to the first hub 200 of the upper stage (S9).

The first hub 200 copies the confirmation signal AR′ received from the second hub 300 to transmit the copied signal AR″ to the signal processor 110 in the base station transceiver system 100 of the upper stage (S10).

When receiving the copied confirmation signal AR″ from the first hub 200, the signal processor 110 transmits a control signal SP (S11) including initial setting information to each of the RRUs 120, 210 and 310 of the lower stages.

At this time, the signal processor 10 may transmit a different control signal using the unique information assigned to each of the RRUs 120, 210 and 310.

The first hub 200 transmits the control signal SP to the RRU 310 of the lower stage according to the unique information included in the control signal SP, which is received from the signal processor 110.

At this time, when the unique information included in the control signal SP is unique information of the RRU 310 connected to the second hub 300 of the lower stage, the first hub 200 transmits the control signal SP (S12) to the second hub 300 and the second hub 300 transmits the control signal SP to the RRU 310 (S13).

Further, the RRU 310 sets its initial performance according to initial setting information included in the control signal SP that is received through each of the hubs 200 and 300, and transmits a performance confirmation signal SS to the second hub 300 of the upper stage (S14).

When receiving the performance confirmation signal SS from the RRU 310, the second hub 300 copies and transmits a performance confirmation signal SS′ to the first hub 200 of the upper stage (S15), and the first hub 200 copies and transmits a performance confirmation signal SS″ of the RRU 310 to the signal processor 110 of base station transceiver system 100 (S16).

Meanwhile, when the initial performance setting is completed, the RRU 310 generates a dynamic report signal DS in a predetermined period to transmit it to the second hub 300 of the upper stage (S17). When receiving a dynamic report signal DS from the RRU 310, the second hub 300 copies it and transmits dynamic report signal DS′ to the first hub 200 of the upper stage (S18).

The first hub 200 transmits dynamic report signal DS″, according to the dynamic report signal DS′ received from the second hub 300, to the signal processor 110 of the base station transceiver system 100 of the upper stage (S19).

That is, after the RRU 310 is connected to the base station transceiver system 100 over the network and its initial performance is set, the RRU 310 generates a dynamic report signal including current performance information in a predetermined period and transmits it to the base station transceiver system 100.

In addition, when the signal processor 110 of the base station transceiver system 100 should control the performance of each of the RRUs 120, 210 and 310, the signal processor 110 transmits the control signal SP including performance setting information to the lower stage (S20).

For example, when the signal processor 110 should control the performance of the RRU 310 connected to the lower stage of the second hub 300, the signal processor 110 transmits the control signal SP to the first hub 200.

The first hub 200 transmits the received control signal SP to the second hub 300(S21), and the second hub 300 transmits the received control signal SP to the RRU (S22).

At this time, the signal processor 110 transmits the control signal SP using the unique information assigned to the RRU 310 whose performance is to be controlled, and each of the hubs 200 and 300 may transmit the control signal SP to the relevant RRU 310 according to the unique information included in the control signal SP.

Further, the RRU 310 resets its performance according to the received control signal SP, and transmits, to the second hub 300, a performance confirmation signal SS including information to inform that the performance has been reset (S23). The second hub 300 copies the performance confirmation signal SS received from the first hub 200 and transmits performance confirmation signal SS′ to the first hub 200 (S24).

The first hub 200 receives the performance confirmation signal SS′ and transmits the performance confirmation signal SS″ to the signal processor 110 of the base station transceiver system 100 (S25).

Meanwhile, FIG. 4B is a diagram illustrating a signal flow when a new hub 400 is connected over the network. Referring to FIG. 4B, when the new hub 400 is connected over the network, the new hub 400 transmits an initialization signal HI to the second hub 300 of the upper stage (S27).

When receiving the initialization signal HI from the new hub 400, the second hub 300 transmits the initialization information HI, including the structure information of the new hub 400 of the lower stage, to the first hub 200 of the upper stage (S28).

The first hub 200 transmits the initialization information HI, including the structure information of the second hub 300 and the new hub 400 of the lower stage, to the signal processor 110 of the base station transceiver system 100 (S29).

And, the signal processor 110 in the base station transceiver system 100 recognizes the structure of the lower stages based on the structure information included in the initialization signal HI transmitted from each of the hubs 200, 300 and 400 of the lower stages, re-assigns a level to each of the hubs 200, 300 and 400, and transmits a hub arrangement signal (HA) to each hub (S30, S31, S32) through each hub back to new hub 400.

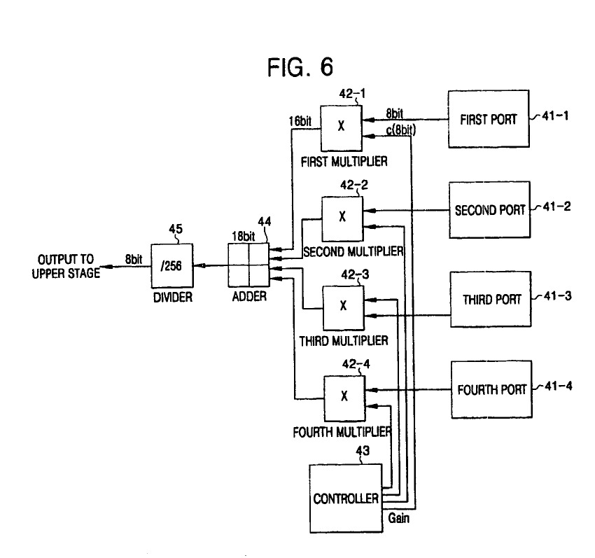

FIG. 6 is an internal block diagram illustrating the configuration of a hub according to an exemplary embodiment of the present invention.

Referring to FIG. 6, a hub according to the present invention includes a divider 45, an adder 44, a plurality of multipliers 42-1 to 42-4, and a gain controller 43.

It is preferable that the plurality of multipliers 41-1 to 42-4 are provided to correspond to a plurality of ports 41-1 to 41-4 included in the hub, and control the intensity of a signal received through each of the ports 41-1 to 41-4 according to a gain control signal transmitted from the gain controller 43.

And, the adder 44 adds the signals whose intensities are controlled by each of the multipliers 42-1 to 42-4. The divider 45 divides the resulting sum signal from the adder 44 into a signal having a predetermined size and outputs the signal to the upper stage.

At this time, the signals received through the respective ports 41-1 to 41-4 are baseband signals transmitted from the RRUs 120, 210 and 310 or the hub of the lower stage, namely, digital signals having a size of a predetermined bit.

Further, the gain controller 43 calculates a gain based on the total number of the RRUs 120, 210 and 310 connected to the lower stage, and the number of the RRUs 120, 210 and 310 connected through the ports 41-1 to 41-4 to generate a weighted gain signal, and transmits the weighted gain signal to each of the multipliers 42-1 to 42-4.

The gain controller 43 calculates and generates the weighted gain signal, as in the following Equation 1:

$$weighted gain signal ( c ) = d \sqrt{\frac{b}{a}} \qquad Equation 1$$

In Equation 1, ‘a’ is the total number of RRUs connected to the lower stage of a relevant hub, ‘b’ is the number of RRUs connected through ports of the relevant hub, and ‘d’ is a variable for converting the calculated weighted gain signal to a predetermined bit of digital signal.

For example, when the baseband signal received through the ports of the second hub 300 in the base station transceiver system 100 is an 8-bit digital signal, as shown in FIG. 3, the gain controller 43 calculates a weighted gain signal for the digital signal that is received from each port, using Equation 1.

That is, the gain controller 43 calculates a 8-bit weighted gain signal for the digital signal received through each port, by applying ‘4’ as an ‘a’ value since the total number of the RRUs connected to the lower stage of the second hub 300 is ‘4’, applying ‘1’ as a ‘b’ value since the number of the RRUs transmitting a digital signal through each port is ‘1’, and applying ‘256’ as a ‘d’ value since the digital signal received through each port is 8 bits.

The gain controller 43 transmits the calculated weighted gain signal to each of the multipliers 42-1 to 42-4 that correspond to the ports 41-1 to 41-4, respectively.

At this time, the weighted gain signal that the gain controller 43 transmits to each of the multipliers 42-1 to 42-4 may be an 8-bit digital signal having a value of

$$256 \times \sqrt{\frac{1}{4}} .$$

And, each of the multipliers 42-1 to 42-4 multiplies the 8-bit digital signal received through each of the corresponding ports 41-1 to 41-4 by the 8-bit weighted gain signal received from the gain controller 43, and outputs a 16-bit digital signal. The adder 44 adds the 16-bit digital signals received from the respective multipliers 42-1 to 42-4, and transmits an 18-bit digital signal to the divider 45.

The divider 45 divides with 256 as a denominator value in order to convert the received 18-bit digital signal to an 8-bit digital signal.

The divider 45 transmits an 8-bit digital signal, calculated by the division calculation, to the first hub 200 of the upper stage.

Further, the gain controller 43 of the first hub 200 calculates an 8-bit weighted gain signal for the digital signal received through the first, second, and third ports by applying ‘7’ as an ‘a’ value since the total number of the RRUs 210 and 310 connected to the lower stage is ‘7’, by applying ‘1’ as a ‘b’ value since the number of the RRUs 210 that transmit a digital signal through the first, second, and third ports is ‘1’, and by applying ‘256’ as a ‘d’ value since the digital signal received through the first, second, and third ports is 8 bits.

And, the gain controller 43 calculates an 8 bit weighted gain signal received through the fourth port by applying ‘4’ as the ‘b’ value since the number of the RRUs 310 of the lower stage connected through the fourth port is ‘4’.

At this time, the weighted gain signal that the gain controller 43 transmits to the multipliers 42-1 to 42-3 each corresponding to the first, second, and third ports is an 8-bit digital signal having a value of 256×\sqrt{1/7}, and the weighted gain signal that the gain controller 43 transmits to the fourth multiplier 42-4 corresponding to the fourth port may be an 8-bit digital signal having a value of

$$256 \times \sqrt{\frac{4}{7}} .$$

Each of the multipliers 42-1 to 42-4 multiplies the 8-bit digital signal received through each of the ports 41-1 to 41-4 by the 8-bit weighted gain signal received from the gain controller 43 to output a 16-bit digital signal, and the adder 44 adds the 16-bit digital signals received from each of the multipliers 42-1 to 42-4 to obtain an 18-bit digital signal.

The adder 44 transmits the obtained 18-bit digital signal to the divider 45.

The divider 45 divides with 256 as a denominator value in order to convert the received 18-bit digital signal to an 8-bit digital signal to be transmitted to the upper stage over the network.

The divider 45 transmits the calculated 8-bit digital signal to the signal processor 110 of the base station transceiver system 100 of the upper stage.

That is, the first hub 200 uniformly maintains the intensities of the digital signals received from the respective RRUs 210 and 310 by imparting a higher weight weighted gain to the digital signal received through the fourth port, since the digital signal received through the fourth port is an added signal obtained by adding digital signals transmitted from the four RRUs 310 connected to the second hub 300 of the lower stage and the digital signal received through the first, second, and third ports is a digital signal transmitted from one RRU 210.

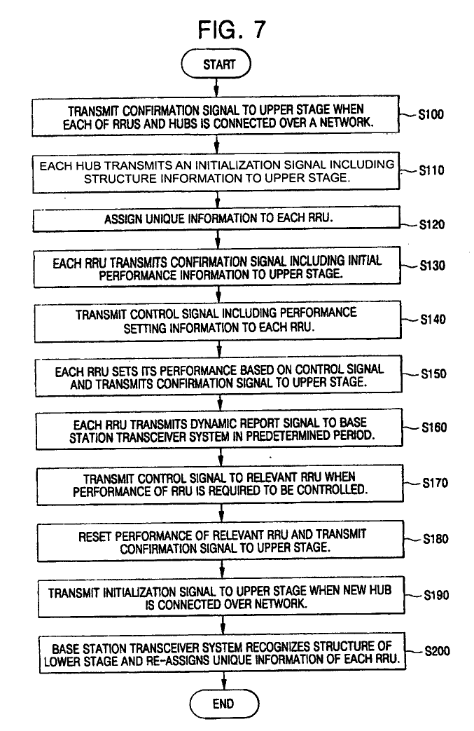

FIG. 7 is a flowchart illustrating a method for processing a signal according to an exemplary embodiment of the present invention.

Referring to FIG. 7, when a plurality of remote RF units (RRUs) are connected through a plurality of hubs to a base station transceiver system (BTS) over a network, each of the RRUs respectively transmits a confirmation signal including performance information to the base station transceiver system of an upper stage (S100) through corresponding hubs.

Each of the hubs recognizes the structure of the lower stage based on the confirmation signal received from the RRU of the lower stage connected over the network, and transmits an initialization signal including structure information to the hubs or the base station transceiver system of the upper stages (S110).

The base station transceiver system recognizes the connection structure of the hubs and the RRUs of the lower stages based on the initialization signal transmitted from each hub of the lower stage, and assigns unique information to each RRU connected over the network (S120) and transmits hub arrangement signals to the lower stage.

That is, the base station transceiver system recognizes the connection structure of the respective hubs configured in the lower stages, sequentially assigns levels to the respective hubs, and transmits hub arrangement signals to each of the hubs to assign unique information to each port.

When each RRU is assigned the unique information from the base station transceiver system, it transmits a confirmation signal including initial performance information to the base station transceiver system through the hub of the upper stage (S130).

When receiving the confirmation signal including initial performance information from each RRU, the base station transceiver system generates a control signal based on the preset setting information of the RRU and transmits the control signal to each RRU (S140).

Each RRU sets its performance based on the control signal received from the base station transceiver system, and transmits a performance confirmation signal informing that the performance has been set, to the base station transceiver system of the upper stage (S150).

At this time, the base station transceiver system transmits a control signal using the unique information assigned to each RRU, and each hub transmits the control signal to the relevant RRU according to the unique information included in the received control signal.

Each RRU sets its performance according to the control signal received from the base station transceiver system, and then generates a dynamic report signal including state information in a predetermined period to transmit the generated dynamic report signal to the base station transceiver system though each connected hub (S160).

On the other hand, when the base station transceiver system should control the performance of each RRU, for example, improve the output performance of one RRU, the base station transceiver system transmits a control signal for controlling the performance of the relevant RRU, to the relevant RRU (S170).

At this time, the base station transceiver system transmits the control signal using the unique information assigned to relevant RRU, and the hub connected to the relevant RRU over the network may transmit the control signal to the relevant RRU according to the unique information included in the control signal.

The RRU receiving the control signal from the base station transceiver system resets its performance according to the performance information included in the control signal, and transmits the performance confirmation signal to the base station transceiver system through the connected hub (S180).

Further, when a new hub is connected over the network, the new hub transmits an initialization signal to the base station transceiver system of the upper stage over the network (S190).

At this time, when the new hub is connected to the lower stage of an existing hub, the new hub transmits an initialization signal to the existing hub of the upper stage, and the existing hub transmits initialization information including connection structure information of the new hub of the lower stage, to the base station transceiver system of the upper stage.

When receiving the initialization signal from the new hub, the base station transceiver system recognizes the connection structure of the lower stages, re-assigns a level to each hub, and resets unique information of each RRU connected to each hub through the network.

The base station transceiver system transmits a hub arrangement signal including the reset unique information of each hub to each hub, and each hub assigns new unique information to each RRU (S200).

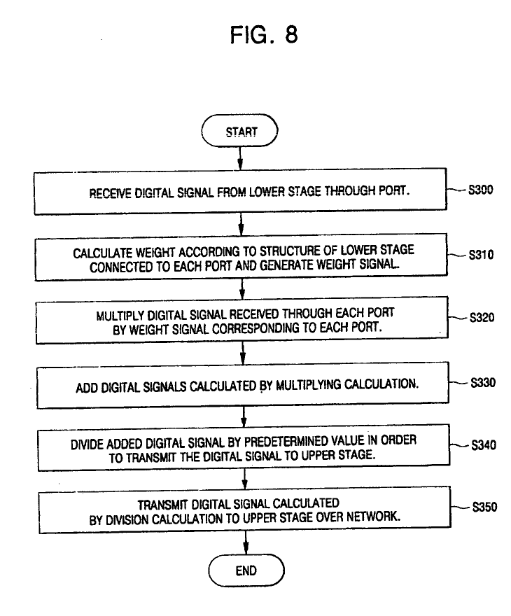

FIG. 8 is a flowchart illustrating a method for processing a signal according to an exemplary embodiment of the present invention.

Referring to FIG. 8, when a base station transceiver system BTS and a plurality of remote RF units (RRUs) are connected through a plurality of hubs over a network, each of the RRUs transmits a confirmation signal to the base station transceiver system in a predetermined period.

And, each hub transmits an initialization signal, that includes structure information for the RRUs and the hubs connected to the lower stages, to the base station transceiver system of the uppermost stage, and recognizes information on the total number of the RRUs connected to the lower stages and information on the number of the RRUs connected through the ports, from a hub arrangement signal received from the base station transceiver system.

Further, the hub receives a digital signal from the RRU or the hub of the lower stage (S300). For example, when a mobile station establishes its call with another mobile station or another network through the base station transceiver system, the RRU converts an analog signal received from the mobile station to the digital signal, and transmits the digital signal to the hub of the upper stage.

The hub generates a weighted gain signal to be imparted to the digital signal that is received through each port (S310).

At this time, the hub generates a weighted gain signal corresponding to the digital signal received through each port based on the total number (a) of the RRUs connected to the lower stage and the number (b) of the RRUs connected through the ports, as in the foregoing Equation 1.

The hub multiplies the digital signal received through each port by the weighted gain signal corresponding to each port (S320).

For example, when the digital signal received through the port is a 8-bit digital signal, the hub generates a 8-bit weighted gain signal corresponding to the received digital signal based on the number of the RRUs connected to the lower stage, and multiplies the received 8-bit digital signal by the generated 8-bit weighted gain signal to obtain a 16-bit digital signal.

The hub adds the 16-bit digital signals obtained by multiplying the digital signal received through each port by the 8-bit weighted gain signal corresponding to each port (S340).

At this time, when the number of the hub port is four, four 16-bit digital signals are added to calculate an 18-bit digital signal.

The hub divides the 18-bit digital signal by 256 in order to transmit the 8-bit digital signal to the upper stage.

That is, the hub converts the calculated 18-bit digital signal to the 8-bit digital signal capable of being transmitted to the upper stage.

The hub transmits the converted 8-bit digital signal to the upper stage over the network (S350).

As described above, according to the present invention, there is an advantage that it is possible to provide a mobile communication service to more mobile stations in the service area of the base station transceiver system by effectively connecting remote RF units (RRUs) as RF units to the base station transceiver system.

There is an advantage that the base station transceiver system may individually control the performance of each RRU using unique information assigned to each RRU connected over the network.

Further, there is another advantage that it is possible to provide a uniform quality of service to a plurality of mobile stations, each provided with a mobile communication service through different RRUs from each other, by applying and processing a signal, exchanged between a plurality of RRUs, to a different weighted gain according to a connection structure.

Although only the embodiments of the present invention have been described in detail, it will be apparent to those skilled in the art that a variety of variations and modification may be made to the present invention without departing from the technical spirit of the present invention, and there is no doubt that such variations and modifications will be included in the appended claims.

1. An apparatus for processing a signal in a base station transceiver system connected with a plurality of radio frequency (RF) units through a plurality of ports, the apparatus comprising:
a gain controller for providing a weighted gain signal corresponding to a signal received through each port according to a connection structure of each of the radio frequency units connected through each port; and
a signal processor for converting the signals to a signal having a predetermined size according to the signal received through each port and the weighted gain signal provided from the gain controller, and outputting the converted signal over a network.

2. The apparatus as claimed in claim 1, wherein the gain controller recognizes information on the total number of the radio frequency units connected through each port and information on the number of the radio frequency units transmitting a signal through each port to generate the weighted gain signal, the weighted gain signal corresponding to each port based on the recognized information.

3. The apparatus as claimed in claim 1, wherein the weighted gain signal is generated by the gain controller using the following equation:
$$weighted gain signal ( c ) = d \sqrt{\frac{b}{a}}$$
where, ‘a’ is the total number of radio frequency units connected to a lower stage of a relevant hub, ‘b’ is the number of radio frequency units connected through ports of the relevant hub, and ‘d’ is a variable for converting the calculated weighted gain signal to a predetermined bit of digital signal.

4. The apparatus as claimed in claim 1, wherein the network is at least one of a local area network (LAN) and a wireless local area network (WLAN).

5. The apparatus as claimed in claim 1, wherein the signal processor comprises:
a plurality of multipliers for multiplying the signal received through each port by the weighted gain signal corresponding to each port;
an adder for adding signals calculated by the multipliers; and
a divider for dividing the calculated signals by a predetermined value as a divisor and outputting a resultant signal to the network, in order to transmit the signal calculated by the adder to the network.

6. The apparatus as claimed in claim 5, wherein the divider divides using a size value of the signal added at the adder as a dividend and using a predetermined value as a divisor, the predetermined value being capable of converting the added signal to a signal of a predetermined size to allow the added signal to be transmitted over the network.

7. A mobile communication system comprising:
at least one remote radio frequency unit (RRU) for, when connecting to a base station transceiver (BTS) system over a network, converting an radio frequency signal, which is an analog signal transmitted from a mobile station (MS), to a baseband signal of a digital signal, transmitting a confirmation signal including performance information to the base station transceiver system, and establishing performance according to a control signal transmitted from the base station transceiver system;
at least one hub connected to the at least one radio frequency unit over the network, for transmitting an initialization signal according to a connection structure of a lower stage to the base station transceiver system, and for assigning unique information to each of the radio frequency units according to an arrangement signal transmitted from the base station transceiver system; and
the base station transceiver system for, when receiving the confirmation signal and the initialization signal over the network, assigning unique information according to the connection structure of each radio frequency unit and hub, generating a control signal for controlling performance of each radio frequency unit based on the unique information, and transmitting the control signal over the network.

8. The system as claimed in claim 7, wherein each hub comprises at least one port that exchanges each signal over the network and adds a plurality of signals received from the at least one radio frequency unit or at least one hub through each port with application of gains of different weights.

9. The system as claimed in claim 7, wherein each of the hubs recognizes information on the total number of the radio frequency units connected to each of the ports and information on the number of the radio frequency units that transmits a signal to each port, and calculates a gain to be imparted to a signal received through each port based on each recognized number information.

10. A method for processing a signal in a mobile communication system connected to at least one radio frequency (RF) unit through a plurality of ports, the method comprising:
recognizing a connection structure of a lower stage from a signal transmitted from each of the radio frequency units;
calculating a gain to be applied to a signal received through each port, based on the recognized connection structure, and generating a weighted gain signal corresponding to each port; and
calculating a signal to be transmitted over the network, based on the signal received through each port and the weighted gain signal corresponding to each port.

11. The method as claimed in claim 10, wherein the weighted gain signal is generated using the following equation:
$$weighted gain signal ( c ) = d \sqrt{\frac{b}{a}}$$
where, ‘a’ is the total number of radio frequency units connected to a lower stage of a relevant hub, ‘b’ is the number of radio frequency units connected through ports of the relevant hub, and ‘d’ is a variable for converting the calculated weighted gain signal to a predetermined bit of digital signal.

12. The method as claimed in claim 10, wherein calculating the signal comprises:
multiplying the signal received through each port by the weighted gain signal corresponding to each port to obtain a plurality of multiplication signals, respectively;
adding the obtained multiplication signals to obtain an addition signal; and
dividing the obtained addition signal by a predetermined value as a divisor to obtain a predetermined signal.

13. The method as claimed in claim 12, wherein the predetermined signal is a digital signal having a predetermined bit value that is transmitted over the network.

14. The method as claim in claim 13, wherein the network is at least one of a local area network (LAN) and a wireless local area network (WLAN).

15. A method for processing a signal in a mobile communication system in which a plurality of remote radio frequency units (RRUs) are connected to a base station transceiver system through at least one hub, the method comprising:
transmitting, by each of the radio frequency units, a confirmation signal including initial information to the hub or the base station transceiver system of an upper stage when connecting to the base station transceiver system over the network;
recognizing, by each hub, a connection structure of the lower stage to transmit an initialization signal including structure information to the base station transceiver system when connecting to the base station transceiver system or receiving the confirmation signal from the radio frequency unit;
assigning, by the base station transceiver system, unique information to each hub and each radio frequency unit based on the connection structure of the lower stage; and
individually controlling, by the base station transceiver system, performance of each radio frequency unit by transmitting to each radio frequency unit a control signal including performance control information using the assigned unique information.

16. The method as claimed in claim 15, further comprising setting, by each radio frequency unit, its performance in response to the control signal, and transmitting a dynamic report signal including state information in a predetermined period.

17. The method as claimed in claim 15, further comprising:
transmitting an initialization signal including structure information to the hub or the base station transceiver system of the upper stage when the new hub is connected over the network; and
re-assigning, by the base station transceiver system, unique information to each hub or each radio frequency unit according to the structure information included in the received initialization signal.

18. The method as claimed in claim 15, wherein transmitting the initialization signal by the hub comprises transmitting the initialization signal including connection structure information of the lower stage to the hub or the base station transceiver system of the upper stage when the confirmation signal is received from the radio frequency unit of the lower stage over the network.

19. The method as claimed in claim 15, wherein transmitting the control signal comprises:
generating, by the base station transceiver system, a control signal and transmitting the control signal to the hub of the lower stage using the unique information assigned to one radio frequency unit whose performance is to be controlled; and
recognizing, by the hub, a port through which the control signal is to be output, from the unique information included in the control signal, and outputting the control signal to the port.

20. The method as claimed in claim 15, wherein assigning the unique information comprises:
recognizing, by the base station transceiver system, the connection structure of the lower stage from the initialization signal;
assigning the unique information to the ports of each hub based on the recognized connection structure; and
assigning the unique information to each radio frequency unit according to the unique information assigned to each port in a path, along which the confirmation signal transmitted by each radio frequency unit is transmitted to the base station transceiver system.
